(19) United States
(12) Patent Application Publication
(10) Pub. No.: US 2013/0303749 A1
(43) Pub. Date: Nov. 14, 2013

(54) METHOD AND A SYSTEM FOR PRODUCING NANOCELLULOSE, AND NANOCELLULOSE

(71) Applicants: Annikki Vehniaeinen, Helsinki (FI); Sirkka Gustafsson, Kangasala (FI); Timo Koskinen, (US)

(72) Inventors: Annikki Vehniaeinen, Helsinki (FI); Helmer Gustafsson, Kangasala (FI); Timo Koskinen, Valkeakoski (FI)

(73) Assignee: UPM-KYMMENE CORPORATION, Helsinki (FI)

(21) Appl. No.: 13/990,599

(22) PCT Filed: Nov. 25, 2011
(86) PCT No.: PCT/FI11/51042

§ 371 Date: Jul. 8, 2013

(30) Foreign Application Priority Data
Nov. 30, 2010 (FI) 20106261

(51) Int. Cl. C08B 1/00; B01J 19/00

(52) U.S. Cl. CPC C08B 1/00; B01J 19/00
USPC 536/56; 422/255

(57) ABSTRACT

A method and system for producing nanocellulose are provided. Cellulose is refined by a first refiner, the refined cellulose is separated by a first separator in such a manner that at least part of it belongs to an accepted fraction, water is removed from the accepted fraction by a precipitator and the accepted fraction is refined by a second refiner to produce nanocellulose.

### FIELD OF THE INVENTION

The invention relates to a method and a system for producing nanocellulose. The invention also relates to nanocellulose produced by means of the method.

### BACKGROUND OF THE INVENTION

The properties of nanoparticles often differ significantly from the properties of macroscopic pieces. One such substance is nanocellulose, the properties of which differ significantly from the properties of normal cellulose. By using nanocellulose, it is possible to provide a product with, for example, better tensile strength, lower porosity and at least partial translucency, when compared with the use of cellulose. Nanocellulose also differs from cellulose in its appearance, because nanocellulose is a gel-like material. Because of the properties of nanocellulose, it has become a desired raw material, and products containing nanocellulose would have several uses in industry.

In practice, it has been problematic to implement the production of nanocellulose in industrial scale by means of apparatuses of prior art. Problems are caused for example by the especially high consumption of energy involved in the production of nanocellulose. Furthermore, it has been challenging to implement the methods used in a laboratory for production of nanocellulose in production scale. For this reason, there is a need in the industry for a solution by means of which nanocellulose could also be produced with apparatuses of production scale and/or with lower consumption of energy than at present.

### BRIEF SUMMARY OF THE INVENTION

It is an aim of the present invention to solve the above-mentioned problem of producing nanocellulose in production scale in such a way that nanocellulose could be produced by means of a method suitable for industrial scale. Another aim of the present invention is to solve the above-mentioned problem in the consumption of energy in such a way that nanocellulose could be produced with lower consumption of energy than at present. A novel method and system for producing nanocellulose is disclosed. Furthermore, nanocellulose produced by the new method is presented.

Surprisingly, it has been discovered that by means of the method for producing nanocellulose according to the invention it may be possible to produce especially clean, finished nanocellulose for industrial needs. Surprisingly, it has also been discovered that by means of the method according to the invention it is possible to produce nanocellulose with energy costs which are ⅓ lower when compared to a method of prior art.

In the method for producing nanocellulose according to one embodiment, cellulose-based material is refined by means of a first refiner, the refined material is separated by means of a first separator in such a manner that at least part of it belongs to an accepted fraction, water is removed from said accepted fraction by means of a precipitator and material belonging to said accepted fraction is refined by means of a second refiner to produce nanocellulose.

According to an advantageous example, material is also separated by means of a second separator into accepted and/or rejected fraction in the method. Said separation, by means the second separator preferably takes place after the refining by means of the second refiner.

According to an advantageous example, at least part of the material separated by means of the first separator belongs to the rejected fraction. Thus, in the method said rejected fraction is preferably conveyed back to the first refiner.

According to an advantageous example, said first refiner and/or said second refiner are/is a conical refiner.

According to an advantageous example, the blades of at least said second refiner are substantially flat (without edges).

According to an advantageous example at least one separator is a pressure separator comprising a perforated screen, in which the diameter of one single hole is approximately 0.2 mm.

The system for producing nanocellulose according to one embodiment comprises a first refiner for refining the cellulose, a first separator for separating the material refined by means of said first refiner in such a manner that at least part of it belongs to an accepted fraction, a precipitator for reducing the amount of water in the accepted fraction and a second refiner for refining the material belonging to the accepted fraction to produce nanocellulose.

According to an advantageous example, the system also comprises a second separator for separating the material after the refining performed by said second refiner into accepted and/or rejected fraction.

According to an advantageous example, said first refiner and/or said second refiner are/is a conical refiner. According to an advantageous example, the blades of at least said second refiner are substantially flat (without edges).

The nanocellulose according to the present invention comprises nanocellulose produced by means of the method or system according to the invention.

The process of producing nanocellulose according to the invention can be arranged for example as a separate production unit or it can be positioned for example in a pulp mill or a paper mill.

### DESCRIPTION OF THE DRAWINGS

In the following, the invention will be described in more detail with reference to the appended drawing, in which

FIG. 1 shows a system according to one embodiment for producing nanocellulose.

### DETAILED DESCRIPTION OF THE INVENTION

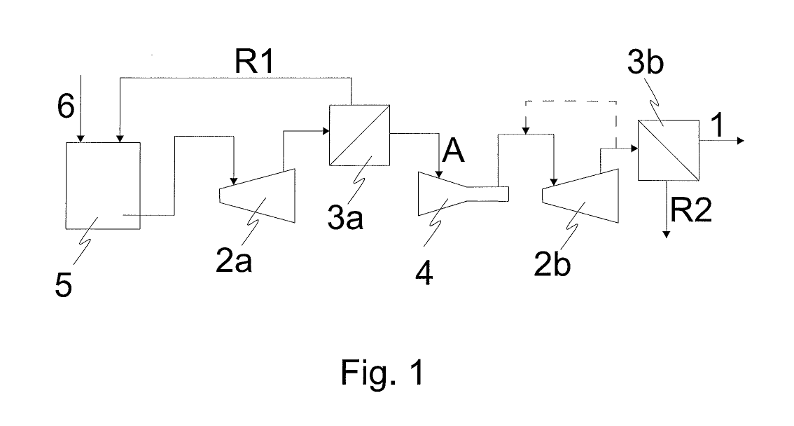

In this application, reference is made to FIG. 1, in which the following reference numerals are used:
1 nanocellulose,
2a first refiner,
2b second refiner,
3a first separator,
3b second separator,
4 precipitator,
5 pulp container,
6 raw material (cellulose),
R1, R2, rejected fraction i.e. reject, and
A accepted fraction i.e. accept.

In this application, nanocellulose refers to such cellulose-based material, in which the median length of particles is not greater than 10 μm, typically not greater than 1 μm, and the median diameter of the particles is smaller than 1 μm, suitably ranging from 2 nm to 200 nm. Nanocellulose typically appears as an almost colourless, gel-like material.

FIG. 1 shows a system according to one embodiment for producing nanocellulose. In the method according to the invention, cellulose 6 is refined by at least two separate refiners 2a, 2b.

According to an advantageous example, the raw material 6, i.e. cellulose is conveyed to a pulp container 5. Before refining with a first refiner 2a, at least part of the cellulose can be pre-treated for example chemically. According to an advantageous example, at least part of the cellulose 6 is treated with an oxidizing chemical before the refining of the refiner 2a to reduce the consumption of energy. According to an advantageous example, at least part of the cellulose 6 is treated before the refining of the first refiner 2a in a so-called cationization treatment, which can be carried out for example to improve the homogeneity of the mixture and to attain so-called “gentle” refining.

In an advantageous example, carboxymethylation reaction is utilized in the pre-treatment of the cellulose.

From the pulp container 5, cellulose 6 is conveyed to the first refiner 2a. The first refiner 2a may be for example a pre-defibrator, or it may be the actual refiner.

According to an advantageous example, material is refined with the first refiner 2a in a relatively low consistency so that the consistency of the raw material 6 conveyed to the refiner 2a is under 10%, more advantageously approximately 1 to 5%, for example 2 to 4%. The first refiner 2a may be for example a disc refiner or a conical refiner.

According to an advantageous example, the first refiner 2a is a gently refining defibrator the purpose of which is to “open” the fibre. If the refiner 2a is a conical refiner, it according to the one example, differs from a conical refiner of prior art in such a manner that large fibre bundles containing several fibres will not be able to travel through the blade grooves of the refiner.

According to an advantageous embodiment, the aim is to control the refining of the first refiner 2a in such a manner that the way to treat each fibre to be refined would remain as constant as possible. Variables to be controlled include for example the blade gap of the refiner 2a and/or the speed of the refiner 2a and/or the feeding pressure of the refiner 2a.

After prerefining by the first refiner 2a, the raw material 6 is conveyed further to the first separator 3a. The separator 3a can be for example a pressure separator with a densely perforated plate, in which only small fibres extend through the densely perforated plate. The diameter of the openings in the perforated plate of the separator can be for example approximately 0.2 mm. Typically, the accept and reject flows of the separator are controlled for the part of the separator.

The reject R1 of the first separator 3a is advantageously circulated back to the first refiner 2a. In practice, the reject R1 is advantageously conveyed to the refiner 2a for example through the pulp container 5. The reject R1 of the first separator 3a can also be conveyed to a separate reject refiner. The accept A of the separator 3a is advantageously conveyed to a precipitator 4.

The purpose of the precipitator 4 is to increase the dry matter content of said raw material and/or to wash the raw material 6. In the precipitator 4 the dry matter content of the raw material is increased advantageously over 10%, for example at least into 15%, or at least into 20%. The precipitator 4 can be any pulp precipitator of prior art. After precipitation the dry matter content of the raw material is adjusted to the refining consistency of the second refiner 2a, if necessary.

After the precipitation carried out by the precipitator 4, the refined raw material is conveyed to the second refiner 2b. The cellulose material refined at least once in the second refiner 2b is refined further to produce nanocellulose, preferably by means of a grinding refining method. The refining by means of the second refiner 2b can be carried out for example by means of a disc refiner or a conical refiner. Advantageously, the refining is conducted by means of a conical refiner. According to one example, the refining consistency of the second refiner 2b is advantageously under 10%, for example 1 to 5 % or 2 to 4 %.

The second refiner 2b is advantageously a so-called refiner without edges, i.e. the blades of the refiner 2b are advantageously substantially flat and/or they have a grit surface. This may be important when material is refined into nanocellulose, because as a result of the edges, small particles can move through the refiner 2b without treatment. According to one example, the second refiner 2b comprises several refining zones, such as for example two or at least three refining zones, wherein at least the blades of the last refining zone are without edges, i.e. substantially flat or provided with a grit surface.

According to an advantageous embodiment, the aim is to control the refining of the first refiner 2b in such a manner that the way to treat each fibre to be refined would remain as constant as possible. The variables to be controlled vary on the basis of the refiner type in use. Typically such variables may include for example the blade gap of the refiner 2b and/or the speed of the refiner 2b.

After the refining by means of the second refiner 2b, the raw material 6 has been refined into nanocellulose. After the second refiner 2b the refined material can also be conveyed to a second separator 3b, if desired. The second separator 3b can be for example a pressure separator equipped with a perforated plate. Thus, the diameter of one single hole in the perforated plate is advantageously for example approximately 0.2 mm or even slightly larger. Instead of the perforated plate, it is also possible to use for example a slotted plate. The slotted plate is often especially advantageous for removing so-called “clots” discharged from the piping. By means of the slotted plate the ball-shaped particle is separated and removed from the process typically more efficiently than when using a perforated plate.

The second separator 3b can be used for example to ensure the refining of cellulose entirely into small particles. The rejected R2 of the second separator 3b can thus be conveyed, for example, back to the second refiner 2b. The purpose of the second separator 3b is preferably to ensure that the so-called “clots” discharged from the piping for example under the effect of bacterial action or possibly released from the blades of the refiner will not enter into the finished nanocellulose product. Thus, the reject of the second separator R2 is advantageously removed from the system.

It is also possible that the system does not comprise the second separator 3b at all. It is also possible to supplement the process with one or several other refiners in addition to said first 2a and second refiner 2b. According to an example, at least one refiner can be arranged for example to refine the rejected fraction R of the first or second separator.

### Example

Nanocellulose was produced by refining cellulose by means of two different refiners. The refiner of the first stage was a low consistency refiner. The consistency of the pulp when led to the refiner was approximately 3%. The specific energy consumption (EOK) at the refiner was 100 to 300 MWh/h.

After the first refiner, pulp was separated by means of a first separator. The first separator was a pressure separator with a 0.2 mm perforated screen.

The consistency of the pulp to be fed to the separator was approximately 3%, and the reject ratio of the separator was 10%. The ratio of the fraction of the size under 200 micrometers (so-called 200 fraction) in the accept was 80 to 85%. The rejected fraction of said separator was conveyed back to refining to the first refiner, to which such an amount of replacing unrefined cellulose was also conveyed which substantially corresponded to the amount of pulp transferred from the first separator onward in the process as an accepted fraction.

After the separation the accepted fraction was precipitated and washed. This was implemented in such a manner that after the separator the pulp diluted to a consistency of approximately 0.2% was led to precipitation. In the precipitation an apparatus of a decanter centrifuge type having the capacity of approximately 5 m³/h was used. In the precipitator the dry matter content was increased into approximately 15%.

After the precipitation the pulp was diluted again to a consistency of approximately 3%, whereafter the diluted pulp was conveyed to the second refiner. The second refining stage of the diluted pulp was carried out by means of a Masuko apparatus in accordance with prior art.

Surprisingly, it was observed that due to the solution according to the invention, the energy consumption in the production of nanocellulose was approximately ⅓ lower than when producing nanocellulose straight from fibres.

The invention is not limited solely to the examples presented in FIG. 1 and in the above description, but the invention is characterized in what will be presented in the following claims.

1-12. (canceled)

13. A method for producing nanocellulose, in which method cellulose is refined by a first refiner,
the refined cellulose is separated by a first separator in such a way that at least part of it belongs to an accepted fraction,
water is removed from said accepted fraction by a precipitator, and
said accepted fraction is refined by a second refiner to produce nanocellulose.

14. The method according to claim 13, further comprising separating a material from the material in a second separator, after the refining by the second refiner.

15. The method according to claim 13, wherein part of the material separated by the first separator belongs to a rejected fraction, and:
said rejected fraction is conveyed back to the first refiner.

16. The method according to claim 13, wherein said first refiner and/or said second refiner is a conical refiner.

17. The method according to claim 13, wherein at least said second refiner includes blades that are substantially flat (without edges).

18. The method according to claim 13, wherein the first separator is a pressure separator comprising a perforated screen.

19. The method according to claim 18, wherein the diameter of one single hole of the perforated screen is approximately 0.2 mm.

20. The method according to claim 14, wherein the second separator is a pressure separator comprising a perforated or slotted screen.

21. The method according to claim 20, wherein the second separator is a pressure separator comprising a perforated screen, in which the diameter of one single hole is approximately 0.2 mm.

22. A system for producing nanocellulose, said system comprising:
a first refiner for refining cellulose,
a first separator for separating the material refined by the first refiner in such a way that at least part of it belongs to an accepted fraction,
a precipitator for reducing the amount of water in said accepted fraction, and
a second refiner for refining the material belonging to the accepted fraction to produce nanocellulose.

23. The system according to claim 22, wherein in the system also comprises a second separator for separating the material refined by the first and second refiners, the second separator being positioned after the second refiner.

24. The system according to claim 22, wherein said at first refiner and/or said second refiner is a conical refiner.

25. The system according to claim 22, wherein the blades of said second refiner includes blades that are substantially flat (without edges).

26. The system according to claim 22, wherein the first separator is a pressure separator comprising a perforated screen.

27. The system according to claim 26, wherein the diameter of one single hole of the perforated screen is approximately 0.2 mm.

28. The system according to claim 23, wherein the second separator is a pressure separator comprising a perforated or slotted screen.

29. The system according to claim 28, wherein the second separator is a pressure separator comprising a perforated screen, in which the diameter of one single hole is approximately 0.2 mm.

30. Nanocellulose produced by the method according to claim 13.

31. Nanocellulose produced by the system of claim 22.
